(19) United States
(12) Patent Application Publication
(10) Pub. No.: US 2003/0016318 A1
(43) Pub. Date: Jan. 23, 2003

(54) Color display

(76) Inventors: Wei-Chen Liang, Hsinchu (TW); Pin Chang, Hsinchu (TW); Heng-Chung Wu, Hsinch Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/909,948

(22) Filed: Jul. 23, 2001

(51) Int. Cl. G02F 1/1335

(52) U.S. Cl. 349/106

(57) ABSTRACT

The present invention provides a color display comprising a plurality of pixels. Each of the pixels comprises at least two sub-pixels, each being composed of at least two colors. At least two data transmission lines of the same color in each line of the longitudinally-arranged pixels are joined together by a conductive line to be connected to the same driving part and simultaneously controlled. The present invention can let a display of lower resolution have better color mixing effect to obtain displaying effect commensurate with that of a high-level display. Moreover, the problem of zigzagged or brick-shaped pictures can be improved.

### FIELD OF THE INVENTION

The present invention relates to a display and, more particularly, to a color display having better color mixing effect.

### BACKGROUND OF THE INVENTION

Displays play the roles as output devices for showing pictures and texts in the present information society. Along with the development of information products toward compactness, flat panel displays become the mainstream of electronic application products gradually. Applications of flat panel displays become more frequent in various kinds of electrical appliances of everyday lives.

In a display, the output of its color image is composed of a plurality of pixels on a panel. An image is formed by pixels of different colors and brightness. As shown in FIG. 1, in a prior art display, each pixel 12 is divided into three sub-pixels 14 of the three primary colors: red (R), green (G), and blue (B). In a color driving module 10, a set of data transmission lines (segment) 16 and a set of signal scan lines (common) 18 are provided for longitudinally-arranged sub-pixels 14 and transversally-arranged sub-pixels 14, respectively. The lines 16 and 18 are driven by semiconductor driving parts 20 and 22, respectively. Magnitudes of voltages are exploited to individually control the brightness of each sub-pixel 14. Through mixing the three primary colors of different brightness, a display can accomplish the effect of full colors.

The design of the above color driving module 10 can obtain better quality of image and color mixing effect for high-level and high-color displays such as displays having resolution higher than 160×160. However, the design of the driving circuit thereof is complex, the fabrication process is more difficult, and more semiconductor driving parts 20 and 22 are required, resulting in a higher cost. Therefore, the above color driving module 10 cannot apply to all products. For displays of lower resolution, the above color driving module 10 will result in zigzagged or brick-shaped pictures, hence limiting the color mixing effect. Accordingly, the present invention aims to propose an improved color driving module of a display to resolve the above problems.

### SUMMARY OF THE INVENTION

The primary object of the present invention is to propose a color display, wherein each sub-pixel of each pixel is divided into several portions of different colors to obtain finer images and better color mixing effect and to achieve displaying effect commensurate with that of a high-level display.

Another object of the present invention is to provide a low-cost color display capable of displaying images of high quality so that zigzagged or brick-shaped pictures can be avoided.

Yet another object of the present invention is to provide a low-level color display, which can be manufactured using the original fabrication process and equipments to obtain the displaying effect of high quality of image.

According to the present invention, a panel in a display has tidily arranged pixels. Each of the pixels comprises at least two sub-pixels. Each of the sub-pixels is composed of at least two colors. A set of signal scan lines and a set of data transmission lines are electrically connected to transversely-arranged sub-pixels and longitudinally-arranged colors, respectively. At least two of the data transmission lines connecting the same color in each line of longitudinally-arranged pixels are joined together through a conductive line to be connected to the same driving part.

The various objects and advantages of the present invention will be more readily understood from the following detailed description when read in conjunction with the appended drawings, in which:

### BRIEF DESCRIPTION OF THE DRAWINGS

FIG. 1 is a diagram of a color driving module in the prior art;

FIG. 2 is a structure diagram of a liquid crystal display (LCD);

FIG. 3 is a diagram of a color driving module of the present invention;

FIG. 4 is a partly enlarged view of the present invention; FIG. 5 is a diagram according to another embodiment of the present invention; and

FIG. 6 is a structure diagram of an organic light emitting diode (OLED).

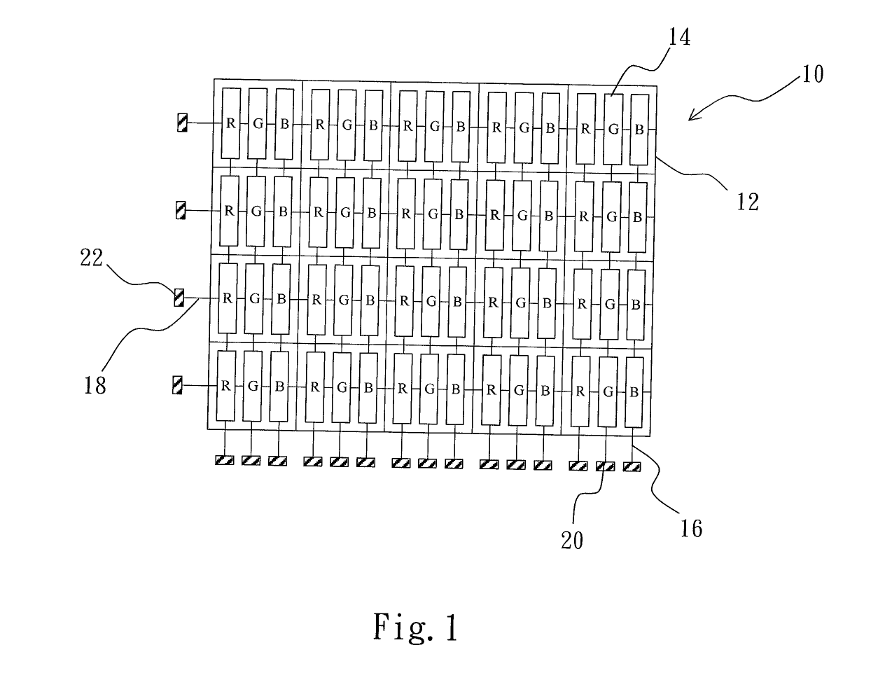

### DETAILED DESCRIPTION OF THE PREFERRED EMBODIMENTS

The present invention is characterized in that each sub-pixel in each pixel is divided into at least two colors, and a driving part of each data transmission line can simultaneously control at least two data transmission lines driving the same color to let a color display have better displaying effect. The characteristics of the present invention will be illustrated below through two embodiments: a liquid crystal display (LCD) and an organic light emitting diode (OLED).

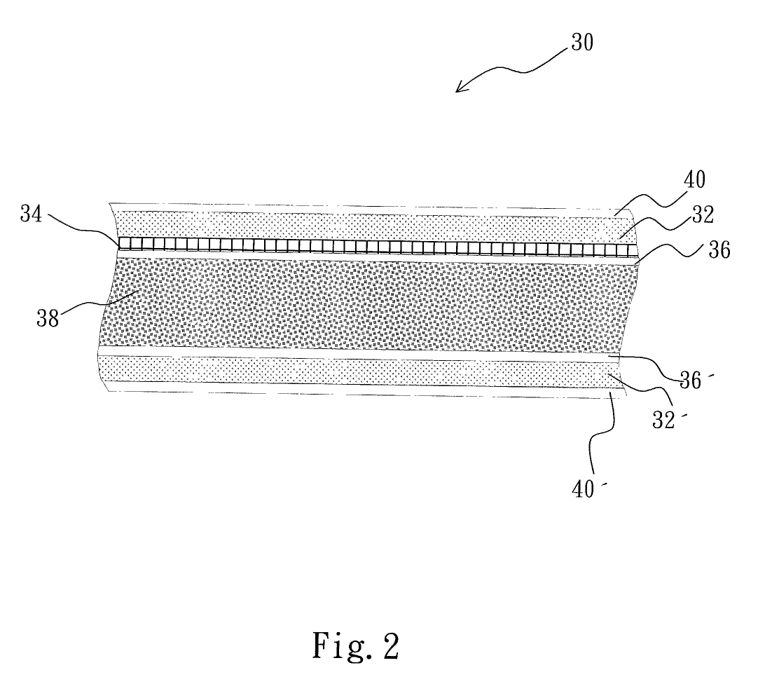

As shown in FIG. 2, a general color LCD 30 comprises two parallel spaced transparent substrates 32 and 32′. A color filter 34, a transparent electrode plate 36, a liquid crystal layer 38, and a transparent electrode plate 36′ are sandwiched from top to bottom between the two transparent substrates 32 and 32′. An upper polarizer 40 and a lower polarizer 40′ cover over outer surfaces of the two transparent substrates 32 and 32′, respectively. The color filter 34 is composed of a plurality of tidily arranged pixels 42, each comprising more than two sub-pixels 44. Each of the sub-pixels 44 is divided into at least two different colors 46.

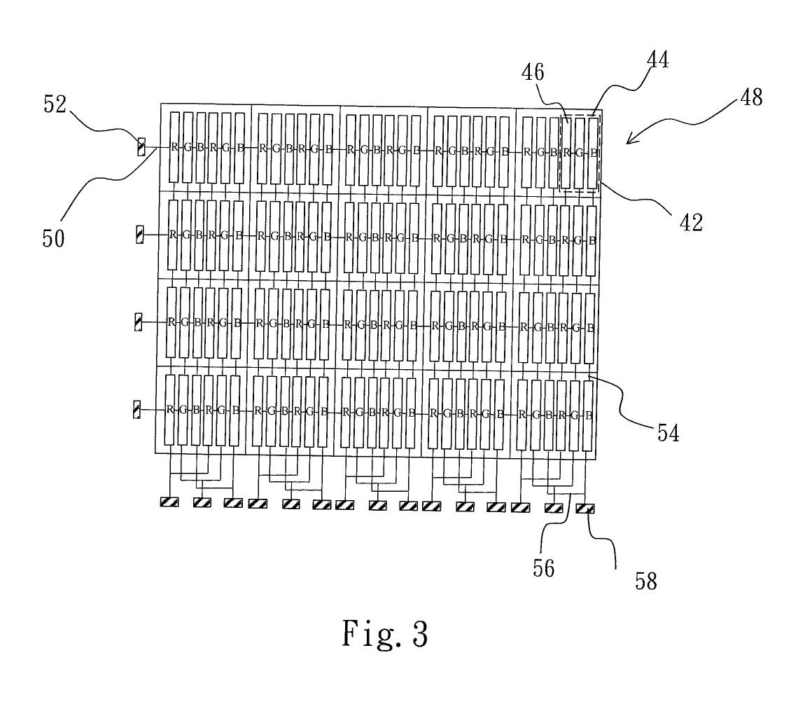

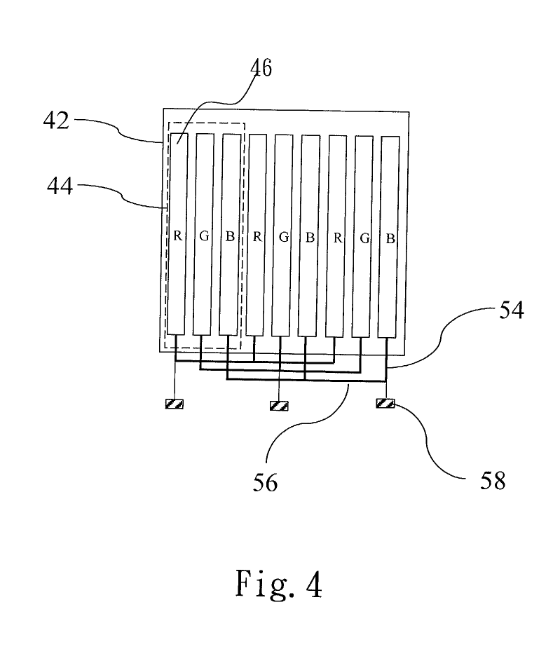

As shown in FIG. 3, a color driving module 48 of the present invention forms a plurality of tidily arranged pixels 42 on the color filter 34. Each of the pixels 42 comprises two sub-pixels 44. Each of the two sub-pixels 44 is composed of three colors 46 of R, G, and B. Each line of the transversely-arranged sub-pixels 44 are electrically joined together by a signal scan line 50 to connect the sub-pixels 44 of the same row to a driving part 52. Each line of the longitudinally-arranged colors 46 are electrically joined together by a data transmission line 54. After each of the data transmission lines 54 joins the colors 46 of the same column together, an U-shaped conductive line 56 is used to connect the two data transmission lines 54 connecting the same colors 46 in each line of the longitudinally-arranged pixels 42 so that the two data transmission lines 54 can be connected to the same driving part 58 to be simultaneously controlled.

The signal scan lines 50 and the data transmission lines 54 are composed of an upper layer and a lower layer of indium tin oxide (ITO), respectively. The upper and lower layers of ITO are uniformly arranged on the transparent electrode plates 36 and 36′, respectively. The way of arrangement of liquid crystal molecules in the liquid crystal layer 38 is controlled by an electric field to change the transmission ratio of a display for displaying an image. The above driving parts 52 and 58 can be active type separate integrated circuit (IC) devices.

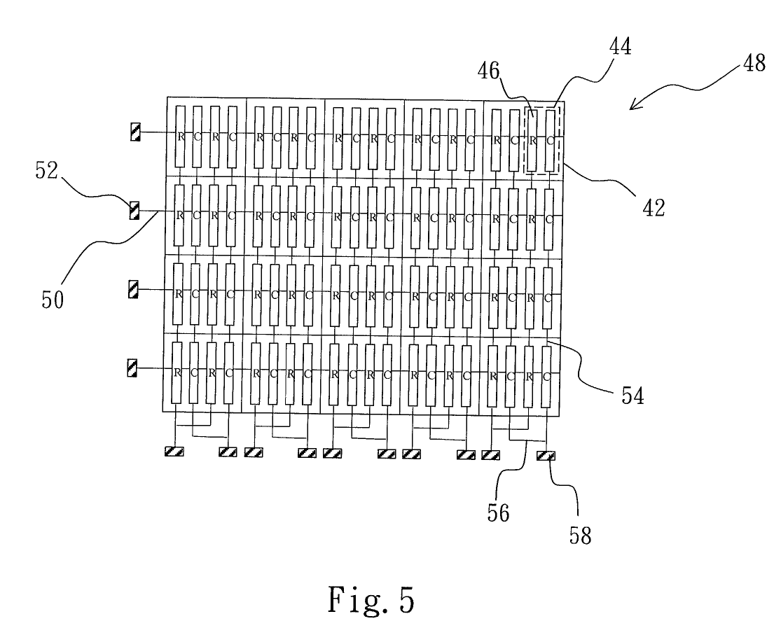

In the above color driving module 48, if each pixel 42 on the color filter 34 comprises three sub-pixels 44, as shown in FIG. 4, and each sub-pixel 44 also comprises the three primary colors, three data transmission lines 54 connecting the same color 46 in each line of the longitudinally-arranged pixels 42 are connected to the same driving part 58 by a conductive line 56 of dually U shape to be simultaneously controlled.

In addition to the above embodiment wherein each sub-pixel 42 comprises three colors, in the color driving module 48, as shown in FIG. 5, each pixel 42 on the color filter 34 can comprise two sub-pixels 44, and each sub-pixel 44 can comprise two complementary colors 46, e.g., red (R) and its complementary color: cyan (C). Each signal scan line 50 disposed on the transparent electrode plate 36 electrically connects each line of transversely-arranged sub-pixels 44 to connect the sub-pixels 44 of the same row to the same driving part 52. After each data transmission line 54 electrically connects the same colors of the same column, a U-shaped conductive line 56 is used to connect every two data transmission lines 54 connecting the same colors 46 in each line of the longitudinally-arranged pixels 42 to the same driving part 58. Similarly, each pixel 42 on the color filter 34 can comprise more than three sub-pixels 44, each comprising complementary colors 46. The ways of connection and arrangement of the signal scan lines 50 and the data transmission lines 54 on the transparent electrode plate 36 are the same as the above embodiments and thus will not be further described.

In the present invention, because each sub-pixel 44 in each pixel 42 is divided into at least two different colors 46, and at least two data transmission lines 54 of the same color are simultaneously controlled, a low-level display of large pixels and low count of pixels such as a display with resolution of 32×32, 48×48, and 64×64 will have better color mixing effect to obtain color displaying effect commensurate with that of a high-level display. Moreover, zigzagged or brick-shaped pictures can be avoided. Additionally, the display of the present invention can be manufactured using the original fabrication process and equipments. Furthermore, the design of using the driving part 58 to simultaneously drive at least two data transmission lines 54 can reduce the difficulty of fabricating the color driving module 48, have the advantage of better controllability, and decrease the count of driving parts so that the present invention has both the characteristics of high quality of image and low cost.

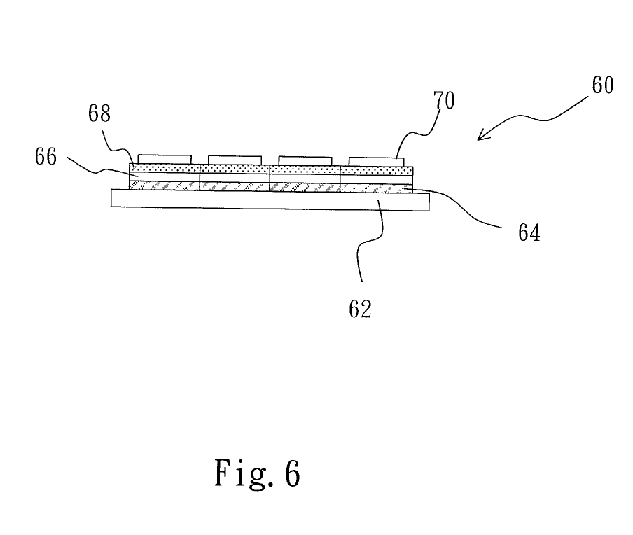

Additionally, the present invention can apply to an OLED 60. As shown in FIG. 6, an electrode layer of ITO 64, a protection film 66, a light emitting layer 68, and a metal electrode layer 70 are disposed on a glass substrate 62 in this order. Three kinds of light-emitting materials of organic molecules are uniformly coated on the light-emitting layer 68. The three kinds of light-emitting materials can emit out the three colors of R, G, and B, respectively. Each sub-pixel 44 in each pixel 42 is composed of the three colors 46. When electrified, electrons of outer shells of organic molecules will be excited to a higher energy level and then drop to the lower energy level, emitting out photons having an energy of this difference of energy levels. Therefore, the pixels can show colors. The arrangement way of the light-emitting materials and the driving way of the electrodes are the same as the arrangement and connection way of the sub-pixels and the colors in the above LCD and thus will not be further described.

The arrangement of the above pixels 42 can be designed to be a dot-matrix shape or an irregular shape, and the arrangement of the colors 46 on the pixel 42 can be a straight-line shape or a rectangular grid shape.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A color display achieving color images by controlling contrast of brightness of a plurality of tidily arranged pixels, each of said pixels comprising at least two sub-pixels, each of said sub-pixels comprising at least two colors, each line of said transversely-arranged sub-pixels being electrically connected together by a signal scan line, each line of said longitudinally-arranged colors being electrically connected together by a data transmission scan line, at least two of said data transmission lines connecting the same color in each line of said longitudinally-arranged pixels being joined together by a conductive line to be connected to the same driving part.

2. The color display as claimed in claim 1, wherein said sub-pixel comprises a primary color and its complementary color.

3. The color display as claimed in claim 1, wherein said sub-pixel comprises the three primary colors of red, green, and blue.

4. The color display as claimed in claim 1, wherein said pixel can be designed to be a dot-matrix shape or an irregular shape.

5. The color display as claimed in claim 1, wherein the arrangement of said colors on said pixel can be selected among a straight-line shape and an alternate rectangular grid shape.

6. The color display as claimed in claim 1, wherein said driving part is an active type separate IC device.
